(19) United States
(12) Patent Application Publication
(10) Pub. No.: US 2007/0161498 A1
(43) Pub. Date: Jul. 12, 2007

(54) DIELECTRIC PORCELAIN AND PRODUCING METHOD THEREOF

(75) Inventor: Shinsuke Takeoka, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/562,193

(22) Filed: Nov. 21, 2006

(30) Foreign Application Priority Data
Nov. 22, 2005 (JP) 2005-337390

(51) Int. Cl. C04B 35/462; C04B 35/465

(52) U.S. Cl. 501/134; 501/135; 501/136; 501/137; 501/139

(57) ABSTRACT

One inventive aspect provides a dielectric porcelain having a high permittivity and a producing method therefor, by sintering a perovskite type oxide at a low temperature, utilizing a sintering additive in an amount less than in the related technology. One embodiment provides a dielectric porcelain including, after sintering, a perovskite type oxide as a principal component and a sintering additive, wherein the sintering additive has such a property that a densification temperature becomes lower along with an increase in a content thereof above a boundary content and becomes lower and then higher along with a decrease in the content thereof below the boundary content, and the content of the sintering additive is less than the boundary content and is in a region where the densification temperature is low. Another embodiment provides a producing method for such dielectric porcelain, including addition of a sintering additive in such amount. In another embodiment, the perovskite type oxide is represented by a general formula ABO₃, of which an A-site/B-site ratio is within a range of from 0.98 to 1.03, the sintering additive contains B and Li, or B, Li and Si by substituting a part of B with Si, and a content of B, Li and Si is within a range of from 0.1 to 4.0 mol % when calculated as B₂O₃, Li₂O and SiO₂, with respect to the perovskite type oxide as 100 mol %.

### BACKGROUND OF THE INVENTION

1. Field of the Invention

The present invention relates to a dielectric porcelain, and more particularly to a dielectric porcelain densified by a low-temperature sintering with an addition of a small amount of a sintering additive, and a producing method thereof.

2. Description of the Related Technology

As a result of recent development in mobile communications including mobile phones, demands for dielectric porcelain compositions are increasing as materials for the electronic components for use therein.

In related electronic components, in the case of simultaneously sintering a dielectric porcelain composition and an internal conductor of low electrical resistance such as Ag or Cu, a low-temperature sintering has been made possible by mixing a large amount of a sintering additive (glass component) in a perovskite type oxide constituting the principal component (cf. JP-A-63-224105 and JP-A-2003-2682).

A dielectric porcelain composition disclosed in JP-A-63-224105 contains a perovskite type oxide as a principal component, and also contains, with respect to the principal component, “a glass component in an amount equal to or larger than 5 wt % but less than 40 wt %, wherein, by representing the glass component by a general formula aLi₂O.bBaO.cB₂O₃.(1-a-b-c)SiO₂, values a, b and c satisfy molar relations of 0≦a<0.25, 0.1<b<0.5, 0.1<c<0.5 and 0.3<a+b+c<0.8″. As it contains a large amount of glass component for enabling a sintering at a low temperature equal to or lower than 1050° C., it has drawbacks of a low dielectric constant, a large dielectric loss and a shift in A-site/B-site ratio of the perovskite type oxide ABO₃ as the principal component, induced by BaO contained in the glass component, thus resulting in a deteriorated sintering property.

JP-A-2003-2682 describes a low-temperature sinterable porcelain composition including, with respect to 100 parts by weight of at least a ceramics powder selected from perovskite type oxides, “a glass of a low softening temperature in an amount of from 1 to 20 parts by weight, which contains SiO₂ in a proportion of from 10 to 30 wt %, at least one selected from a group of MgO, CaO, BaO and SrO in a proportion of from 10 to 60 wt %, at least one of Al₂O₃ and B₂O₃ in a proportion of from 20 to 50 wt %, and at least one selected from a group of Li₂O, Na₂O and K₂O in a proportion of from 0 to 30 wt %, with a sum of the aforementioned components representing 95 wt % or more, and which has a softening temperature of 600° C. or lower”. It is also described that “each of samples Nos. 1 to 9 utilizing the low-softening glass of the present invention was densified to a water absorption coefficient of 0.1% or less at a sintering temperature of 1050° C. or less even with a glass amount of 20 wt % or less, and had excellent dielectric characteristics of a relative permittivity of from 6.0 to 120 and a Q value of 2,000 or higher” (paragraph [0046]). However, these formulations were sintered with a glass amount of 10 wt % or higher with respect to the perovskite type oxide and had a low relative permittivity (Table 2). Also the low-temperature sinterable porcelain composition described in JP-A-2003-2682 involves a drawback that an alkali earth oxide contained in the low-softening glass causes a shift in the A-site/B-site ratio of the perovskite type oxide ABO₃ as the principal component, thus resulting in a deteriorated sintering property.

A dielectric porcelain composition, formed of a perovskite type oxide as a principal component and containing a small amount of a sintering additive (glass component), is also known (cf. JP-A-5-6710).

JP-A-5-6710 discloses “a dielectric porcelain composition including, with respect to 100 parts by weight of BaTiO₃ having a content of alkali metal oxides as impurities of 0.03 wt % or less, Nb₂O₅ in an amount of from 0.5 to 3.0 parts by weight, CO₂O₃ in an amount of from 0.1 to 1.0 part by weight, MnO₂ in an amount of 0.05 to 0.5 parts by weight, and an oxide glass principally constituted of BaO—B₂O₃—Li₂O—SiO₂ in an amount of from 0.05 to 2.0 parts by weight”. Owing to a low content in the oxide glass, the composition has a high permittivity and a low dielectric loss, but BaO contained in the oxide glass causes a shift in a Ba/Ti ratio of the principal component BaTiO₃ to deteriorate the sintering property, whereby the sintering temperature is as high as 1200 to 1250° C. (Table 3).

As described above, the sintering temperature and the permittivity are in a trade-off relationship in the related low-temperature sintering technology, so that it is not possible to obtain a dielectric material of a high permittivity by a sintering at a low temperature.

### SUMMARY OF CERTAIN INVENTIVE ASPECTS

Certain inventive aspects are to solve the drawbacks mentioned above, and an object thereof is to provide a dielectric porcelain having a high permittivity and a producing method therefor, by sintering a perovskite type oxide at a low temperature, utilizing a sintering additive in an amount less than in the related technology.

The aforementioned object is accomplished by following means:

(1) A dielectric porcelain including, after sintering, a perovskite type oxide as a principal component and a sintering additive, wherein the sintering additive has such a property that a densification temperature becomes lower along with an increase in a content thereof above a boundary content and becomes lower and then higher along with a decrease in the content thereof below the boundary content, and the content of the sintering additive is less than the boundary content and is in a region where the densification temperature is low.

(2) The dielectric porcelain as described in (1), wherein the densification temperature is about 1080° C. or lower.

(3) The dielectric porcelain as described in (1) or (2), wherein the perovskite type oxide is represented by a general formula ABO₃, of which an A-site/B-site ratio is within a range of from 0.98 to 1.03 approximately.

(4) The dielectric porcelain as described in any one of (1) to (3), wherein the sintering additive contains B and Li.

(5) The dielectric porcelain as described in (4), wherein, in the sintering additive, a part of B is substituted with Si.

(6) A dielectric porcelain including, a perovskite type oxide as a principal component and a sintering additive, wherein the perovskite type oxide is represented by a general formula ABO₃, of which an A-site/B-site ratio is within a range of from 0.98 to 1.03 approximately, the sintering additive contains B and Li, or B, Li and Si by substituting a part of B with Si, and a content of B, Li and Si is within a range of from 0.1 to 4.0 mol % approximately when calculated as B₂O₃, Li₂O and SiO₂, with respect to the perovskite type oxide as 100 mol %.

(7) The dielectric porcelain as described in (6), wherein, in the perovskite type oxide ABO₃, the A-site is formed by at least an element selected from Ba, Sr, Ca and Pb and the B-site is formed by at least an element selected from Ti, Zr, Sn and Hf.

(8) The dielectric porcelain as described in (6) or (7), wherein a proportion of substitution of a part of B with Si, when calculated as B₂O₃ and SiO₂ and represented by a ratio SiO₂/(B₂O₃+SiO₂), is equal to or less than about 90%.

(9) The dielectric porcelain as described in any one of (6) to (8), wherein a content of Li in the sintering additive, when calculated as B₂O₃, Li₂O and SiO₂, is from 14 to 60 mol % approximately as Li₂O with respect to a sum of (B₂O₃+Li₂O+SiO₂) as 100 mol %.

(10) A producing method for a dielectric porcelain including steps of adding a sintering additive to a raw material compound principally constituted of a perovskite type oxide, molding an obtained mixture with an addition of a binder, eliminating the binder and executing a sintering, wherein the sintering additive has such a property that a densification temperature becomes lower along with an increase in a content thereof above a boundary content and becomes lower and then higher along with a decrease in the content thereof below the boundary content, and the sintering additive is added in an amount less than the boundary content and in a region where the densification temperature is low.

(11) The producing method for the dielectric porcelain as described in (10), wherein the densification temperature is about 1080° C. or lower, and the sintering is executed at a temperature equal to or lower than about 1080° C.

(12) The producing method for the dielectric porcelain as described in (10) or (11), wherein the perovskite type oxide is represented by a general formula ABO₃, of which an A-site/B-site ratio is within a range of from 0.98 to 1.03 approximately.

(13) The producing method for the dielectric porcelain as described in any one of (10) to (12), wherein the sintering additive contains B and Li.

(14) The producing method for the dielectric porcelain as described in (13), wherein, in the sintering additive, a part of B is substituted with Si.

Certain inventive aspects have an effect of providing a densified dielectric porcelain by adding, to a perovskite type oxide represented by BaTiO₃, a sintering additive of an amount smaller than in the related technology and by executing a sintering at a temperature of about 1080° C. or lower. Also the dielectric porcelain, having a reduced content in the sintering additive which lowers the permittivity, may be used to obtain an electronic component of excellent characteristics.

### BRIEF DESCRIPTION OF THE DRAWINGS

FIG. 1 is a schematic chart showing a region of an amount of a sintering additive; and

FIG. 2 is a chart showing a relationship between an amount of the sintering additive and a densification temperature (sintering temperature).

### DETAILED DESCRIPTION OF CERTAIN EMBODIMENTS

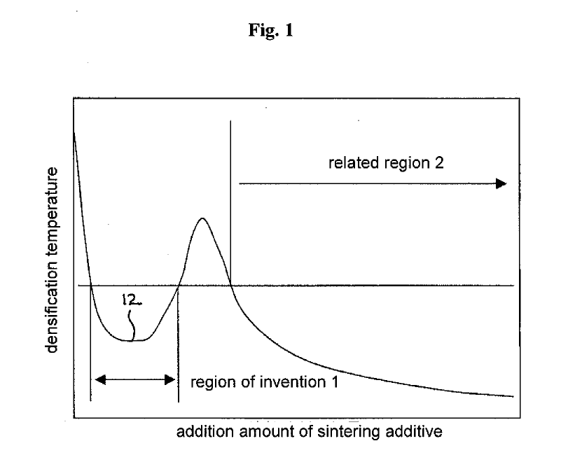

One inventive aspects is related to the finding that, when an addition amount of the sintering additive is changed in case of producing a dielectric porcelain by sintering a perovskite type oxide, the densification temperature becomes higher along with a decrease in the addition amount of the sintering additive as shown in FIG. 1, but, with a further decrease beyond a certain boundary amount, the densification temperature becomes once lower along with a decrease in the addition amount of the sintering additive and then becomes higher. Thus, in advantageous embodiments, the densification temperature as a function of sintering additive concentration exhibits a local minimum 12. The local minimum 12 is advantageously less than 20 mol % sintering additive, and in many embodiments is at less than 10 mol % sintering additive. As explained further below, dielectric compositions in accordance with some embodiments of the invention are created with sintering additive provided in an amount at or near the local minimum 12. Generally, “at or near” refers to the region 1 of FIG. 1.

In the related technology, in order to lower the densification temperature for example to 1080° C. or less, it is necessary to include a sintering additive of an amount considerably larger than such certain amount, for example about 20 mol % or more, so that the dielectric porcelain can be obtained only with a low permittivity. In contrast, certain embodiments as will be described allow to select a composition within a region of a low densification temperature such as about 1080° C. or less even with a content of the sintering additive smaller than the certain amount and to reduce the sintering additive, which is a cause of reduction in the permittivity, to an addition amount of from about a half to 1/10 of that in the related technology, thereby enabling to obtain a dielectric porcelain of a high permittivity by a low-temperature sintering.

Also the present inventor finds that, in the course of a sintering process in a related low-temperature sintering method, an interaction, that an alkali earth added as a part of the sintering additive is solid-dissolved into the perovskite type oxide or that an alkali earth constituting the perovskite type oxide is eluted out into the sintering additive, causes a shift in an A-site/B-site ratio of the perovskite type oxide ABO₃ constituting the principal component, thereby deteriorating the sintering property. In certain embodiments, the total content of the A-site component and the B-site component, contained in the sintered material, is so selected as to enable the sintering at a temperature of about 1080° C. or less, without causing a shift in the A-site/B-site ratio of the perovskite type oxide constituting the principal component.

The perovskite type oxide ABO₃ constituting the principal component preferably has a A-site/B-site ratio within an approximate range of from 0.98 to 1.03. Outside this range, densification at a temperature of about 1080° C. or lower is difficult.

The A-site component and the B-site component used herein mean contents in the sintered material, and need not necessarily constitute a principal phase but include those present as a secondary phase and a glass phase. The A-site may be constituted of at least an element selected from Ba, Sr, Ca and Pb, and the B-site may be constituted of at least an element selected from Ti, Zr, Sn and Hf. There is preferred BaTiO₃, or a material in which a part of Ba is substituted with Ca or Sr, or a material in which a part of Ti is substituted with Zr.

Also for the purpose of regulating electrical characteristics, it is possible to add at least one of rare earths (La, Y, Ho, Dy, Yb and the like), Mg, Mn and Al, while ensuring the sintering property.

The sintering additive preferably contains B and Li, or B, Li and Si by substituting a part of B with Si, and a content of B, Li and Si in the sintered substance (dielectric porcelain) is preferably within a range of from 0.1 to 4.0 mol % approximately when calculated as B₂O₃, Li₂O and SiO₂, with respect to the perovskite type oxide as 100 mol %. Outside this range, densification at a temperature of about 1080° C. or lower is difficult.

When the sintering additive is added in excess of about 4.0 mol %, an A-site/B-site solubility ratio at the dissolution from ABO₃ into liquid phase becomes difficult to control, whereby a dissolution/re-deposition process between ABO₃ and the liquid phase does not proceed properly thereby deteriorating the sintering property while the sintered material also shows a reduced permittivity.

When the sintering additive is added in an amount less than about 0.1 mol %, the liquid phase component at the sintering becomes deficient, thereby deteriorating the sintering property and rendering the sintering at about 1080° C. or less difficult.

In case of substituting a part of B with Si, a preferable proportion of substitution, when calculated as B₂O₃ and SiO₂ and represented by a ratio SiO₂/(B₂O₃+SiO₂) in the sintered substance (dielectric porcelain), is equal to or less than about 90%. Above this range, densification at a temperature of about 1080° C. or lower becomes difficult.

A content of Li in the sintering additive, when calculated as B₂O₃, Li₂O and SiO₂, is preferable from 14 to 60 mol % approximately as Li₂O with respect to a sum of (B₂O₃+Li₂O+SiO₂) as 100 mol %.

The dielectric porcelain can be produced by employing a sintering additive “having such a property that a densification temperature becomes lower along with an increase in a content thereof above a boundary content and becomes lower and then higher along with a decrease in the content thereof below the boundary content”, and by adding the sintering additive in an amount less than the boundary content to a raw material compound principally constituted of a perovskite type oxide, molding an obtained mixture with an addition of a binder, eliminating the binder and executing a sintering at a temperature equal to or lower than about 1080° C.

Also an electronic component such as a multi-layer ceramic capacitor can be obtained by simultaneously sintering a dielectric porcelain composition (ceramic dielectric layer) and an internal electrode, in a method similar to the related technology, as will be described below.

As a material for forming the ceramic dielectric layer, there is prepared a material constituted of a perovskite type oxide such as BaTiO₃ as a principal component, with an addition of a sintering additive constituted of B₂O₃ and Li₂O or of B₂O₃, Li₂O and SiO₂, and further with an addition, if necessary, of a rare earth compound of La, Y, Ho, Dy or Yb, or a compound of Mg, Mn or Al.

As the sintering additive, it is preferable not to add components thereof individually but to add the components as a substance vitrified in advance. In order to achieve a stable vitrification, a part of the A-site component and/or the B-site component, constituting the perovskite type oxide, may be solid dissolved in the glass within a range not exceeding the ranges for the A-site/B-site ratio and for the content of the sintering additive specified above.

The material thus prepared is mixed and kneaded with a binder, a solvent and other additives to obtain a ceramic slurry. The binder may be a polyvinyl butyral resin, polyvinyl alcohol or an acrylic acid polymer. The solvent may be ethanol, isopropyl alcohol or water.

The ceramic slurry thus obtained is coated into a sheet by a coating machine such as a doctor blade coater or a roll coater, onto a longitudinal base film such as a PET film, thereby obtaining a ceramic green sheet.

On such ceramic green sheet, a conductive paste is screen printed to form an internal electrode metal layer. The conductive paste to be employed for forming the internal electrode metal layer is formed by dispersing a metal powder such as of Pt, Pd, Ag, Cu or Ni in a binder.

The ceramic green sheet, bearing the internal electrode metal layer, is punched into a predetermined shape, and is superposed and pressed to obtain a ceramic laminate member. The laminate member is divided by cutting to obtain a laminate chip. Then the laminate chip is heated for eliminating the binder, and is sintered. In one embodiment, the sintering may be executed at a temperature of about 1080° C. or lower.

A conductive paste is baked on the laminate chip after sintering to form an external electrode, thereby obtaining a multi-layer ceramic capacitor. Also the conductive paste may be coated on an unsintered laminate chip and may be based simultaneously with the sintering of the ceramic dielectric layer.

### EXAMPLES

### Example 1

13 samples were prepared by employing BaTiO₃ having an A-site/B-site (Ba/Ti) ratio of 0.99 as the perovskite type oxide of the principal component, employing a sintering additive having a composition of 63 mol % of B₂O₃, 3 mol % of SiO₂ and 34 mol % of Li₂O, and by changing the amount (total amount) of addition of the sintering additive in 13 levels from 0.12 mol % (Experiment No. 1-1) to 46.17 mol % (Experiment No. 1-13), as shown in Table 1.

Each sample formed with BaTiO₃ and the mixture of B₂O₃, SiO₂ and Li₂O was molded utilizing polyvinyl alcohol as a binder, then subjected to elimination of binder at 400° C. and sintered at different sintering temperatures.

The A-site/B-site ratio was measured by an XRF analyzing apparatus. The sample after sintering was crushed in an agate mortar, and, since a particle size and a crystalline structure of the sample affect the X-ray intensity of measurement, a glass bead method was adopted as a pre-treatment for avoiding the influence of such parameters. The sample, mixed with a flux, was fused in a platinum crucible and molded as a glass. Anhydrous lithium tetraborate was used as the flux not containing the elements to be measured. A glass bead thus prepared was set in an XRF apparatus, and the A-site/B-site ratio was measured by a calibration line method.

On the sample sintered as described above, a temperature at which the sample after sintering showed a water absorption coefficient of 0.1% or less was taken as the densification temperature (sintering temperature). The water absorption coefficient was measured according to JIS C2141.

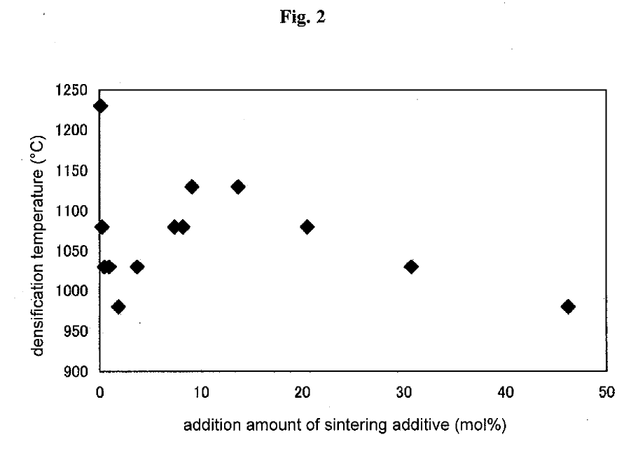

The relationship between the addition amount of the sintering additive and the densification temperature (sintering temperature) is shown in Table 1 and FIG. 2.

TABLE 1

| Experiment | main | A/B | amount of sintering | densification |
|---|---|---|---|---|
| No. | phase | ratio | additive (mol %) | temperature (° C.) |
| 1-1 | BaTiO₃ | 0.99 | 0.12 | 1230 |
| 1-2 | BaTiO₃ | 0.99 | 0.23 | 1080 |
| 1-3 | BaTiO₃ | 0.99 | 0.46 | 1030 |
| 1-4 | BaTiO₃ | 0.99 | 0.92 | 1030 |
| 1-5 | BaTiO₃ | 0.99 | 1.85 | 980 |
| 1-6 | BaTiO₃ | 0.99 | 3.69 | 1030 |
| 1-7 | BaTiO₃ | 0.99 | 7.38 | 1080 |
| 1-8 | BaTiO₃ | 0.99 | 8.21 | 1080 |
| 1-9 | BaTiO₃ | 0.99 | 9.12 | 1130 |
| 1-10 | BaTiO₃ | 0.99 | 13.7 | 1130 |
| 1-11 | BaTiO₃ | 0.99 | 20.5 | 1080 |
| 1-12 | BaTiO₃ | 0.99 | 30.8 | 1030 |
| 1-13 | BaTiO₃ | 0.99 | 46.2 | 980 |

Composition ratio of sintering additive

| B₂O₃ | SiO₂ | Li₂O |
|---|---|---|
| 63% | 3% | 34% |

It was confirmed from Table 1 and FIG. 2, that, in case of sintering a perovskite type oxide utilizing B, Li and Si as the sintering additive, the densification temperature became higher to 1130° C. along with the decrease in the addition amount of the sintering additive to about 9 mol % (Experiment No. 1-9), but the densification temperature then once became lower to less than 1000° C. along with the further decrease in the addition amount of the sintering additive beyond about 9 mol % and became again higher when the addition amount of the sintering additive was decreased beyond 1.85 mol % (Experiment No. 1-5).

Therefore, in order to obtain a low densification temperature for example of 1080° C. or lower within a region where the amount of addition of the sintering additive is less than 9 mol %, it can be identified from Table 1 and FIG. 2 that the amount of addition of the sintering additive may be selected as about from 0.2 to 8% (Experiments Nos. 1-2 to 1-8). As the components B and Li in the sintering additive are lost by sintering, the amount of addition of the sintering additive does not coincide with the content in the sintered substance (low-temperature sintered dielectric porcelain) to be explained later.

### Example 2

Samples were prepared by changing the A-site/B-site (Ba/Ti) ratio of BaTiO₃ to 0.97 (Experiment No. 2-1), 0.98 (Experiment No. 2-2), 0.99 (Experiment No. 2-3), 1.00 (Experiment No. 2-4), 1.01 (Experiment No. 2-5), 1.02 (Experiment No. 2-6), 1.03 (Experiment No. 2-7), and 1.04 (Experiment No. 2-8). As the sintering additive, Experiments Nos. 2-1 to 2-4 employed B₂O₃, SiO₂ and Li₂O (with a total content in the sintered substance of from 2.63 to 3.53 mol %), and Experiments Nos. 2-5 to 2-8 employed B₂O₃ and Li₂O (with a total content in the sintered substance of from 1.37 to 2.21 mol %).

The total content of the sintering additive in the sintered substance was determined by crushing a sintered sample with an agate mortar, then dissolving out the components by an acidolysis method and executing an ICP analysis.

The result of sintering was rated as (+) and (−), in which a sample showing a water absorption coefficient of 0.1% or less after sintering was rated as (+). The water absorption coefficient was measured according to JIS C2141.

These samples were molded as in Example 1, then sintered and subjected to the measurement of sintering temperature (densification temperature). Results are shown in Table 2.

TABLE 2

| | | XRF | amount added at | | | ICP analysis | | | | | | |
|---|---|---|---|---|---|---|---|---|---|---|---|---|
| Exp. | main | analysis | blending (mol %) | | | (mol %) | | | other | sintering temperature | | |
| No. | phase | A/B | B₂O₃ | SiO₂ | Li₂O | B₂O₃ | SiO₂ | Li₂O | additives | 880° C. | 980° C. | 1080° C. |
| 2-1 | BaTiO₃ | 0.97 | 0.44 | 1.76 | 1.77 | 0.20 | 1.76 | 0.67 | | − | − | − |
| 2-2 | BaTiO₃ | 0.98 | 0.44 | 1.76 | 1.77 | 0.20 | 1.76 | 0.67 | | − | − | + |
| 2-3 | BaTiO₃ | 0.99 | 0.44 | 1.76 | 1.77 | 0.40 | 1.76 | 1.10 | | − | + | |
| 2-4 | BaTiO₃ | 1.00 | 0.44 | 1.76 | 1.77 | 0.44 | 1.76 | 1.33 | | + | | |
| 2-5 | BaTiO₃ | 1.01 | 1.44 | | 1.49 | 1.20 | | 1.01 | | + | | |
| 2-6 | BaTiO₃ | 1.02 | 1.44 | | 1.49 | 1.20 | | 1.01 | | + | | |
| 2-7 | BaTiO₃ | 1.03 | 1.44 | | 1.49 | 0.94 | | 0.43 | | − | − | + |
| 2-8 | BaTiO₃ | 1.04 | 1.44 | | 1.49 | 0.94 | | 0.43 | | − | − | − |

It can be seen, from Table 2, that BaTiO₃ having the A-site/B-site (Ba/Ti) ratio within a range of from 0.98 to 1.03 (Experiments Nos. 2-2 to 2-7) can be sintered at 1080° C. or lower, but a case of A-site/B-site ratio excessively small as 0.97 (No. 2-1) or a case of A-site/B-site ratio excessively large as 1.04 (No. 2-8) cannot be sintered at 1080° C. or lower. Therefore, the A-site/B-site ratio is preferably within a range of from 0.97 to 1.03.

### Example 3

Samples were prepared by changing the contents of the sintering additive B₂O₃, Li₂O and SiO₂ (or B₂O₃ and Li₂O) in the sintered substance, taking BaTiO₃ as 100 mol %, to 0.54 mol % (Experiment No. 3-1), 0.18 mol % (No. 3-2), 0.64 mol % (No. 3-3), 0.23 mol % (No. 3-4), 0.11 mol % (No. 3-5), 0.08 mol % (No. 3-6), 3.28 mol % (No. 3-7), 3.64 mol % (No. 3-8), 3.96 mol % (No. 3-9), and 4.05 mol % (No. 3-10). The A-site/B-site (Ba/Ti) ratio of BaTiO₃ was selected as 0.99 (Experiment Nos. 3-1,3-2, 3-7 to 3-10) or as 1.00 (Experiment Nos. 3-3 to 3-6).

These samples were molded as in Example 1, then sintered and subjected to the measurement of sintering temperature (densification temperature). Results are shown in Table 3.

TABLE 3

| | | XRF | amount added at | | | ICP analysis | | | | | | |
|---|---|---|---|---|---|---|---|---|---|---|---|---|
| Exp. | main | analysis | blending (mol %) | | | (mol %) | | | other | sintering temperature | | |
| No. | phase | A/B | B₂O₃ | SiO₂ | Li₂O | B₂O₃ | SiO₂ | Li₂O | additives | 880° C. | 980° C. | 1080° C. |
| 3-1 | BaTiO₃ | 0.99 | 0.07 | 0.29 | 0.30 | 0.07 | 0.29 | 0.18 | | − | + | |
| 3-2 | BaTiO₃ | 0.99 | 0.03 | 0.12 | 0.12 | 0.02 | 0.12 | 0.04 | | − | − | + |
| 3-3 | BaTiO₃ | 1.00 | 0.48 | | 0.50 | 0.38 | | 0.26 | | − | + | |
| 3-4 | BaTiO₃ | 1.00 | 0.24 | | 0.25 | 0.16 | | 0.07 | | − | − | + |
| 3-5 | BaTiO₃ | 1.00 | 0.10 | | 0.15 | 0.07 | | 0.04 | | − | − | + |
| 3-6 | BaTiO₃ | 1.00 | 0.07 | | 0.09 | 0.05 | | 0.03 | | − | − | − |
| 3-7 | BaTiO₃ | 0.99 | 4.64 | 0.23 | 2.51 | 2.09 | 0.23 | 0.96 | | − | − | + |
| 3-8 | BaTiO₃ | 0.99 | 5.16 | 0.26 | 2.79 | 2.32 | 0.26 | 1.06 | | − | − | + |
| 3-9 | BaTiO₃ | 0.99 | 5.44 | 0.28 | 2.95 | 2.53 | 0.28 | 1.15 | | − | − | + |
| 3-10 | BaTiO₃ | 0.99 | 5.73 | 0.29 | 3.10 | 2.58 | 0.29 | 1.18 | | − | − | − |

It can be seen, from Table 3, that cases having the content of the sintering additive in the sintered substance within a range of from 0.11 mol % (No. 3-5) to 3.96 mol % (No. 3-9) can be sintered at 1080° C. or lower, but a case having an excessively small content as 0.08 mol % (No. 3-6) or a case having an excessively large content as 4.05 mol % (No. 3-10) cannot be sintered at 1080° C. or lower. Therefore, the content of B₂O₃, Li₂O and SiO₂ (or B₂O₃ and Li₂O) is preferably within a range of from 0.1 to 4.0 mol %, with respect to the perovskite type oxide as 100 mol %.

### Example 4

Samples were prepared by selecting, with respect to a total amount of B₂O₃, Li₂O and SiO₂ in the sintered substance of 3.65 mol % (as 100 mol %), a Li₂O content of 2.35 mol % (64 mol %) (Experiment No. 4-1), also a Li₂O content of 1.59 mol % (55 mol %) with respect to a total amount of 2.89 mol % (as 100 mol %) (Experiment No. 4-2), a Li₂O content of 0.73 mol % (34 mol %) with respect to a total amount of 2.17 mol % (as 100 mol %) (Experiment No. 4-3), a Li₂O content of 0.73 mol % (24 mol %) with respect to a total amount of 3.08 mol % (as 100 mol %) (Experiment No. 4-4), a Li₂O content of 0.45 mol % (14 mol %) with respect to a total amount of 3.11 mol % (as 100 mol %) (Experiment No. 4-5), a Li₂O content of 0.45 mol % (13 mol %) with respect to a total amount of 3.56 mol % (as 100 mol %) (Experiment No. 4-6), and a Li₂O content of 0.03 mol % (19 mol %) with respect to a total amount of 0.16 mol % (as 100 mol %) (Experiment No. 4-7). The A-site/B-site (Ba/Ti) ratio of BaTiO₃ was selected as 0.99. The ratio SiO₂/(B₂O₃+SiO₂) was selected as 90% in Experiments Nos. 4-1 and 4-2, 81% in No. 4-3, 50% in No. 4-4, 44% in No. 4-5, 38% in No. 4-6, and 92% in No. 4-7.

These samples were molded as in Example 1, then sintered and subjected to the measurement of sintering temperature (densification temperature). Results are shown in Table 4.

TABLE 4

| | | XRF | amount added at | | | ICP analysis | | | | | | |
|---|---|---|---|---|---|---|---|---|---|---|---|---|
| Exp. | main | analysis | blending (mol %) | | | (mol %) | | | other | sintering temperature | | |
| No. | phase | A/B | B₂O₃ | SiO₂ | Li₂O | B₂O₃ | SiO₂ | Li₂O | additives | 880° C. | 980° C. | 1080° C. |
| 4-1 | BaTiO₃ | 0.99 | 0.30 | 1.17 | 6.18 | 0.13 | 1.17 | 2.35 | | − | − | − |
| 4-2 | BaTiO₃ | 0.99 | 0.30 | 1.17 | 4.18 | 0.13 | 1.17 | 1.59 | | − | − | + |
| 4-3 | BaTiO₃ | 0.99 | 0.30 | 1.17 | 1.18 | 0.27 | 1.17 | 0.73 | | − | + | |
| 4-4 | BaTiO₃ | 0.99 | 1.30 | 1.17 | 1.18 | 1.18 | 1.17 | 0.73 | | − | + | |
| 4-5 | BaTiO₃ | 0.99 | 3.30 | 1.17 | 1.18 | 1.49 | 1.17 | 0.45 | | − | − | + |
| 4-6 | BaTiO₃ | 0.99 | 4.30 | 1.17 | 1.18 | 1.94 | 1.17 | 0.45 | | − | − | − |
| 4-7 | BaTiO₃ | 0.99 | 0.02 | 0.12 | 0.07 | 0.01 | 0.12 | 0.03 | | − | − | − |

It can be seen, from Table 4, that cases having the Li₂O content, in the sintering additive, within a range of from 14 to 55 mol % (Experiment Nos. 4-5 to 4-2) with respect to the total amount of B₂O₃, Li₂O and SiO₂ taken as 100 mol %, can be sintered at 1080° C. or lower, but a case having an excessively small content as 13 mol % (No. 4-6) or a case having an excessively large content as 64 mol % (No. 4-1) cannot be sintered at 1080° C. or lower. Therefore, the Li₂O content in the sintering additive, with respect to the total amount of B₂O₃, Li₂O and SiO₂ taken as 100 mol %, is preferably within a range of from 14 to 60 mol %.

Also a case having the ratio SiO₂/(B₂O₃+SiO₂) of 92% (No. 4-7) could not be sintered at 1080° C. or lower. Therefore, the ratio SiO₂/(B₂O₃+SiO₂) is preferably 90 % or less.

### Example 5

Samples were prepared by selecting a total amount of B₂O₃ and Li₂O as the sintering additive, in the sintered substance, at 0.98 mol %, an amount of Li₂O at 0.40 mol % (41% with respect to the total amount), and an A-site/B-site ratio of the perovskite type oxide as the principal component at 1.00, and replacing BaTiO₃ (Experiment No. 5-1) by (Ba_{0.8}Ca_{0.2})TiO₃ (No. 5-2), (Ba_{0.8}Sr_{0.2})TiO₃ (No. 5-3), and Ba(Ti_{0.7}Zr_{0.3})Ti_{0.3} (No. 5-4).

These samples were molded as in Example 1, then sintered and subjected to the measurement of sintering temperature (densification temperature). Results are shown in Table 5.

TABLE 5

| | | XRF | amount added at | | | ICP analysis | | | | | | |
|---|---|---|---|---|---|---|---|---|---|---|---|---|
| Exp. | main | analysis | blending (mol %) | | | (mol %) | | | other | sintering temperature | | |
| No. | phase | A/B | B₂O₃ | SiO₂ | Li₂O | B₂O₃ | SiO₂ | Li₂O | additives | 880° C. | 980° C. | 1080° C. |
| 5-1 | BaTiO₃ | 1.00 | 0.72 | | 0.75 | 0.58 | | 0.40 | | − | + | |
| 5-2 | (Ba_{0.8}Ca_{0.2})TiO₃ | 1.00 | 0.72 | | 0.75 | 0.58 | | 0.40 | | − | + | |
| 5-3 | (Ba_{0.8}Sr_{0.2})TiO₃ | 1.00 | 0.72 | | 0.75 | 0.58 | | 0.40 | | − | + | |
| 5-4 | Ba(Ti_{0.7}Zr_{0.3}) | 1.00 | 0.72 | | 0.75 | 0.58 | | 0.40 | | − | + | |

It can be seen from Table 5 that the sintering is possible at 1080° C. or lower, regardless of the composition of the perovskite type oxide constituting the principal component.

### Example 6

Samples were prepared by selecting an A-site/B-site (Ba/Ti) ratio of BaTiO₃ as 1.00, a total amount of B₂O₃, Li₂O and SiO₂ as the sintering additive in the sintered substance as 1.63 mol %, a Li₂O content of 0.55 mol % (34% with respect to the total amount) and a ratio SiO₂/(B₂O₃+SiO₂) as 81%. There were prepared, in addition to a sample without other additives, samples each containing, as other additives, Ho₂O₃: 0.25 (Experiment No. 6-L), Dy₂O₃: 0.25 (Experiment No. 6-2), Yb₂O₃: 0.25 (Experiment No. 6-3), Y₂O₃: 0.25 (Experiment No. 6-4), MgO: 0.5 (Experiment No. 6-5), MnO: 2.0 (Experiment No. 6-6), Ho₂O₃: 0.25/MnO: 0.5 (Experiment No. 6-7), Dy₂O₃: 0.25/MnO: 0.5 (Experiment No. 6-8), Yb₂O₃: 0.25/MnO: 0.5 (Experiment No. 6-9), MgO: 0.3/La₂O₃: 0.3/MnO: 0.3 (Experiment No. 6-10), and Al₂O₃: 0.3/MnO: 0.3 (Experiment No. 6-11).

These samples were molded as in Example 1, then sintered and subjected to the measurement of sintering temperature (densification temperature). Results are shown in Table 6.

TABLE 6

| | | XRF | amount added at | | | ICP analysis | | | | | | |
|---|---|---|---|---|---|---|---|---|---|---|---|---|
| Exp. | main | analysis | blending (mol %) | | | (mol %) | | | other | sintering temperature | | |
| No. | phase | A/B | B₂O₃ | SiO₂ | Li₂O | B₂O₃ | SiO₂ | Li₂O | additives | 880° C. | 980° C. | 1080° C. |
| 6-1 | BaTiO₃ | 1.00 | 0.22 | 0.88 | 0.89 | 0.20 | 0.88 | 0.55 | Ho₂O₃: 0.25 | − | + | |
| 6-2 | BaTiO₃ | 1.00 | 0.22 | 0.88 | 0.89 | 0.20 | 0.88 | 0.55 | Dy₂O₃: 0.25 | − | + | |
| 6-3 | BaTiO₃ | 1.00 | 0.22 | 0.88 | 0.89 | 0.20 | 0.88 | 0.55 | Yb₂O₃: 0.25 | − | + | |
| 6-4 | BaTiO₃ | 1.00 | 0.22 | 0.88 | 0.89 | 0.20 | 0.88 | 0.55 | Y₂O₃: 0.25 | − | + | |
| 6-5 | BaTiO₃ | 1.00 | 0.22 | 0.88 | 0.89 | 0.20 | 0.88 | 0.55 | MgO: 0.5 | − | + | |
| 6-6 | BaTiO₃ | 1.00 | 0.22 | 0.88 | 0.89 | 0.20 | 0.88 | 0.55 | MnO: 2.0 | − | + | |
| 6-7 | BaTiO₃ | 1.00 | 0.22 | 0.88 | 0.89 | 0.20 | 0.88 | 0.55 | Ho₂O₃: 0.25/MnO: 0.5 | − | + | |
| 6-8 | BaTiO₃ | 1.00 | 0.22 | 0.88 | 0.89 | 0.20 | 0.88 | 0.55 | Dy₂O₃: 0.25/MnO: 0.5 | − | + | |
| 6-9 | BaTiO₃ | 1.00 | 0.22 | 0.88 | 0.89 | 0.20 | 0.88 | 0.55 | Yb₂O₃: 0.25/MnO: 0.5 | − | + | |
| 6-10 | BaTiO₃ | 1.00 | 0.22 | 0.88 | 0.89 | 0.20 | 0.88 | 0.55 | MgO: 0.3/La₂O₃: | − | + | |
| | | | | | | | | | 0.3/MnO: 0.3 | | | |
| 6-11 | BaTiO₃ | 1.00 | 0.22 | 0.88 | 0.89 | 0.20 | 0.88 | 0.55 | Al₂O₃: 0.3/MnO: 0.3 | − | + | |

It can be seen from Table 6 that the sintering is possible at 1080° C. or lower even in case of adding compounds of rare earth, Mn, Mg, Al and the like to the perovskite type oxide constituting the principal component.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope

What is claimed is:

1. A dielectric porcelain comprising a perovskite type oxide as a principal component and a sintering additive, wherein the sintering additive has such a property that the densification temperature of a mixture comprising the perovskite type oxide and the sintering additive becomes lower along with an increase in the content of the sintering additive above a boundary content and becomes lower and then higher along with a decrease in the content of the sintering additive below the boundary content, and the content of the sintering additive is less than the boundary content and is in a region where the densification temperature is low.

2. The dielectric porcelain according to claim 1, wherein the densification temperature is about 1080° C. or lower.

3. The dielectric porcelain according to claim 1, wherein the perovskite type oxide is represented by a general formula ABO₃, of which an A-site/B-site ratio is within a approximate range of from 0.98 to 1.03.

4. The dielectric porcelain according to claim 1, wherein the sintering additive comprises B and Li.

5. The dielectric porcelain according to claim 4, wherein, in the sintering additive, a part of B is substituted with Si.

6. A dielectric porcelain comprising a perovskite type oxide as a principal component and a sintering additive, wherein the perovskite type oxide is represented by a general formula ABO₃, of which an A-site/B-site ratio is within an approximate range of from 0.98 to 1.03, the sintering additive comprises B and Li, or B, Li and Si by substituting a part of B with Si, and the content of B, Li and Si is within a range of from 0.1 to 4.0 mol % when calculated as B₂O₃, Li₂O and SiO₂, with respect to the perovskite type oxide as 100 mol %.

7. The dielectric porcelain according to claim 6, wherein, in the perovskite type oxide ABO₃, the A-site is formed by at least an element selected from Ba, Sr, Ca and Pb and the B-site is formed by at least an element selected from Ti, Zr, Sn and Hf.

8. The dielectric porcelain according to claim 6, wherein a proportion of substitution of a part of B with Si, when calculated as B₂O₃ and SiO₂ and represented by a ratio SiO₂/(B₂O₃+SiO₂), is equal to or less than approximately 90%.

9. The dielectric porcelain according to claim 6, wherein a content of Li in the sintering additive, when calculated as B₂O₃, Li₂O and SiO₂, is approximately from 14 to 60 mol % as Li₂O with respect to a sum of (B₂O₃+Li₂O+SiO₂) as 100 mol %.

10. A method of producing a dielectric porcelain comprising:
adding a sintering additive to a raw material compound comprising a perovskite type oxide;
molding the obtained mixture with an addition of a binder; and
eliminating the binder and executing a sintering,
wherein the sintering additive has such a property that the densification temperature of the mixture becomes lower along with an increase in the content of the sintering additive above a boundary content and becomes lower and then higher along with a decrease in the content of the sintering additive below the boundary content, and the sintering additive is added in a content less than the boundary content and in a region where the densification temperature is low.

11. The method according to claim 10, wherein the densification temperature of the mixture is approximately 1080° C. or lower, and the sintering is executed at a temperature equal to or lower than approximately 1080° C.

12. The method according to claim 10, wherein the perovskite type oxide is represented by a general formula ABO₃, of which an A-site/B-site ratio is within a range of approximately from 0.98 to 1.03.

13. The method according to claim 10, wherein the sintering additive comprises B and Li.

14. The method according to claim 13, wherein, in the sintering additive, a part of B is substituted with Si.

15. A dielectric porcelain produced by the method of claim 10.

16. A composition comprising a perovskite type oxide and a sintering additive, wherein the material exhibits a local minimum of densification temperature as a function of sintering additive concentration, wherein said local minimum is located at less than about 20 mol % sintering additive, and wherein the content of the sintering additive in the composition is at or near said local minimum.

17. The composition according to claim 16, wherein the densification temperature of said material is about 1080° C. or lower.

18. The composition according to claim 16, wherein the perovskite type oxide is represented by a general formula ABO₃, of which an A-site/B-site ratio is within a range of approximately from 0.98 to 1.03.

19. The composition according to claim 16, wherein the sintering additive comprises B and Li.
